(19) United States
(12) Patent Application Publication
(10) Pub. No.: US 2024/0228812 A9
(43) Pub. Date: Jul. 11, 2024

(54) RHEOLOGY MODIFIER COMPOSITIONS AND ARCHITECTURAL COATING COMPOSITIONS DERIVED THEREFROM

(71) Applicant: HERCULES LLC, Wilmington, DE (US)

(72) Inventors: Venkataram KRISHNAN, Avondale, PA (US); Zeena Kottukapally CHERIAN, Exton, PA (US)

(73) Assignee: HERCULES LLC, Wilmington, DE (US)

(21) Appl. No.: 18/278,470

(22) PCT Filed: Feb. 23, 2022
(86) PCT No.: PCT/US2022/017509

§ 371 Date: Aug. 23, 2023

Related U.S. Application Data
(60) Provisional application No. 63/152,442, filed on Feb. 23, 2021.

(51) Int. Cl. C09D 101/28; C08L 1/26; C09D 5/03; C09D 7/43; C09D 7/65; C09D 7/80

(52) U.S. Cl. CPC C09D 101/28; C08L 1/26; C09D 5/03; C09D 7/43; C09D 7/65; C09D 7/80

(57) ABSTRACT

The presently disclosed inventive concept(s) relates generally to a rheology-modifier composition comprising 0.05 wt. % to 70.0 wt. % of an acrylamide polymer having a weight average molecular weight of greater than 6 million Daltons, and 30.0 wt. % to 99.95 wt. % of at least one cellulose ether. Further, the presently disclosed inventive concept(s) also relates to a method of making the rheology modifier composition and an aqueous coating composition comprising the same.

### FIELD OF THE INVENTION

The presently disclosed process(es), procedure(s), method(s), product(s), result(s), and/or concept(s) (collectively referred to hereinafter as the “present disclosure”) relates generally to rheology modifier composition(s) and uses thereof. The present disclosure further relates to architectural coating composition(s) derived from the rheology modifier composition(s).

### BACKGROUND OF THE INVENTION

Hydrophobically modified non-ionic synthetic thickeners (NSAT) such as hydrophobically modified ethylene-oxide based polyurethane (HEUR) generally known as associative rheology modifiers are widely used to thicken or increase the viscosity of a paint to bring optimum application properties such as levelling, sag resistance and the like. These rheology modifiers contain two or more hydrophobes. The function of the hydrophobes is to associate with the surface of the binder latex particles resulting in a network structure that links together individual latex particles thus increasing the viscosity. Also, used in the coating industry is another class of non-associative rheology modifiers. Examples of non-associative rheology modifiers include water-soluble polymers, for example, cellulosic (HEC), starches and the like. Non-associative rheology modifiers increase the viscosity of paint through a thickening mechanism introduced by highly entangled polymer molecules in aqueous solution thus restricting the mobility of the paint. The individual use of polyacrylamides and cellulose ethers, for example, hydroxyethyl cellulose as non-associative thickeners is known in the related art, nevertheless they have been known to have certain deficiencies, for example, stringy or gloppy rheology, poor levelling and dilution tolerance.

U.S. Pat. No. 4,425,469 teaches the use of a water soluble, vinyl addition polymer of acrylamide comprising a hydrophobic terminal group as an adsorbate and as a flow modifier in aqueous systems. The polymer of acrylamide is a homopolymer or a copolymer having terminal hydrophobes which are introduced through a hydrophobic chain transfer agent.

Chinese Patent No. 1225934 teaches a high viscosity powder architectural coating containing sodium carboxymethyl cellulose, hydroxypropyl cellulose and polyacrylamide.

U.S. Pat. No. 9,834,695 assigned to Hercules discloses a rheology modifier composition used for architectural coatings wherein the rheology modifier composition comprises a blend of cellulose ethers such as hydroxyethyl cellulose, ethyl hydroxyethyl cellulose, hydrophobically modified hydroxyethyl cellulose; a cationic polymer such as acrylamidopropyl trim onium chloride, acrylamidopropyl trim onium chloride/acrylamide copolymer; and a dispersant.

Therefore, there is a long-felt need in the art to provide rheology modifier compositions that overcome the drawbacks related with individual uses of acrylamide polymers and cellulose ethers and provides a cost-effective rheology modifier composition with some unanticipated benefits such as improved thickening efficiency, high sag resistance and dilution tolerance, and cost in use.

### SUMMARY OF THE INVENTION

In one aspect, the present disclosure provides a rheology modifier composition comprising a blend of 0.05 wt. % to 70.0 wt. % of an acrylamide polymer having a weight average molecular weight of greater than 6 million Daltons; and 30.0 wt. % to 99.95 wt. % of at least one cellulose ether. In one non-limiting embodiment of the present disclosure, the acrylamide polymer is a non-ionic homopolymer or an anionic copolymer or a cationic copolymer. In one non-limiting embodiment of the present disclosure, the acrylamide polymer is a cationic polymer. In one non-limiting embodiment of the present disclosure, the weight average molecular weight of acrylamide polymer varies in the range of from about 6 million Daltons to about 15 million Daltons, or from 8 million Daltons to about 12 million Daltons. In one non-limiting embodiment of the present disclosure, the cellulose ether is a glyoxal treated cellulose ether or non-glyoxal treated cellulose ether. In another non-limiting embodiment of the present disclosure, the cellulose ether is hydroxyethyl cellulose or carboxymethyl cellulose either alone or in combination thereof. In another non-limiting embodiment of the present disclosure, the cellulose ether is non-glyoxal treated hydroxyethyl cellulose. In yet another embodiment of the present disclosure, the cellulose ether is glyoxal treated hydroxyethyl cellulose. In one non-limiting embodiment of the present disclosure, the rheology modifier composition is a dry powder blend.

In another aspect, the present disclosure provides a method of preparing the rheology modifier composition of the present disclosure, wherein the method comprises blending (i) 0.05 wt. % to 70.0 wt. % of an acrylamide polymer having a weight average molecular weight greater than 6 million Daltons; and (ii) 30.0 wt. % to 99.95 wt. % of at least one cellulose ether.

In still another aspect, the present disclosure provides a use of such rheology modifier compositions in aqueous-based coatings, wherein the composition comprises a blend of (i) 0.05 wt. % to 70.0 wt. % of an acrylamide polymer having a weight average molecular weight greater than 6 million Daltons; and (ii) 30.0 wt. % to 99.95 wt. % of at least one cellulose ether.

In yet another aspect, the present disclosure provides an aqueous coating composition comprising: (ia) 0.01 wt. % to 10.0 wt. % of the rheology modifier composition of the present disclosure or (ib) 0.01 wt. % to 10.0 wt. % of an acrylamide polymer having a weight average molecular weight greater than 6 million Daltons; and 0.01 wt. % to 10.0 wt. % of at least one cellulose ether; (ii) 5.0 wt. % to 85.0 wt. % of at least one film forming polymer; and (iii) 5.0 wt. % to 15.0 wt. % of water, based on the total weight of the coating composition. In one non-limiting embodiment of the present disclosure, the acrylamide polymer and the cellulose ether are both present in the coating composition as a blend. In one non-limiting embodiment of the present disclosure, the aqueous coating composition further comprises at least one pigment. In one non-limiting embodiment of the present disclosure, the aqueous coating composition is an architectural coating composition.

### DETAILED DESCRIPTION OF THE INVENTION

Before explaining at least one embodiment of the inventive concept(s) in detail by way of exemplary drawings, experimentation, results, and laboratory procedures, it is to be understood that the inventive concept(s) is not limited in its application to the details of construction and the arrangement of the components set forth in the following description or illustrated in the drawings, experimentation and/or results. The inventive concept(s) is/are capable of other embodiments or of being practiced or carried out in various ways. As such, the language used herein is intended to be given the broadest possible scope and meaning; and the embodiments are meant to be exemplary—not exhaustive. Also, it is to be understood that the phraseology and terminology employed herein is for the purpose of description and should not be regarded as limiting.

Unless otherwise defined herein, scientific, and technical terms used in connection with the present disclosure shall have the meanings that are commonly understood by those of ordinary skill in the art. Further, unless otherwise required by context, singular terms shall include pluralities and plural terms shall include the singular. Generally, nomenclatures utilized in connection with, and techniques of chemistry described herein are those well-known and commonly used in the art. Reactions and purification techniques are performed according to manufacturer's specifications or as commonly accomplished in the art or as described herein.

All patents, published patent applications, and non-patent publications mentioned in the specification are indicative of the level of skill of those skilled in the art to which this present disclosure pertains. All patents, published patent applications, and non-patent publications referenced in any portion of this application are herein expressly incorporated by reference in their entirety to the same extent as if each individual patent or publication was specifically and individually indicated to be incorporated by reference.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the inventive concept(s) as defined by the appended claims.

As utilized in accordance with the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, and/or the variation that exists among the study subjects. The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

As used herein, the term “acrylamide polymer” means a polymer formed polymerizing acrylamide based repeating units wherein the acrylamide based repeating units may be an acrylamide or a acrylamide substituted on the alpha-carbon atom or on the nitrogen atom.

As used herein, the term “aqueous coatings” have its art-recognized meaning which allows for the inclusion of minor amounts of co-solvents and other volatile organic material provided water constitutes more than 50%, and preferably at least 80% of the volatile phase so that even with the presence of organic solvents these coatings are still regarded as water-borne since the majority of the volatile solvent present in the liquid coating composition is water.

As used herein, the term “architectural coatings” refers to those water borne paints which are characterized in that a resinous binder is solubilized, dispersed or emulsified in an aqueous phase, commonly referred to as the continuous phase which is predominantly water. Suitable water-borne binders can include materials such as starch, modified starch, polyvinyl alcohol, polyvinyl acetate, polyethylene/acrylic acid copolymer, acrylic acid polymers, polyacrylate, polyacrylamide copolymers, acrylonitrile/butadiene/styrene copolymers and polyacrylonitrile. Suitable and non-limiting examples of water-insoluble binders can include polyacrylates, methacrylates, vinyl-acrylics, styrene-acrylics and the like.

One aspect of the present disclosure provides a rheology modifier composition. The rheology modifier composition of the present disclosure comprises a blend of an acrylamide polymer having a weight average molecular weight of greater than 6 million Daltons; and at least one cellulose ether. In one non-limiting embodiment of the present disclosure, the polyacrylamide polymer can be present in an amount of from about 0.05 wt. % to about 70.0 wt. %. The cellulose ether can be present in an amount of from about 30.0 wt. % to about 99.95 wt. %, based on the total weight of the rheology modifier composition.

The acrylamide polymer according to the present disclosure can be a non-ionic homopolymer, an anionic copolymer or a cationic copolymer. In one non-limiting embodiment of the present disclosure, the acrylamide polymer is a homopolymer. In another non-limiting embodiment of the present disclosure, the acrylamide polymer is an anionic copolymer. In yet another non-limiting embodiment of the present disclosure, the acrylamide polymer is a cationic polymer. The anionic copolymer according to the present disclosure comprises at least one monomer unit having one or more acid functional groups or anhydride functional groups, or any combinations thereof, with one or more hetero atoms selected from the group consisting of S, N, O and P. Suitable examples of such monomers can include, but are not limited to, acrylic acid, methacrylic acid, maleic acid or anhydride, itaconic acid or anhydride, acrylamido propane sulfonic acid, vinyl phosphonic acid, and the like. Similarly, suitable examples of cationic polymers can include, but are not limited to, 3-acrylamido propyl trimethyl ammonium chloride, 3-methacrylamido propyl trimethyl ammonium chloride, and the like.

The acrylamide polymer according to the present disclosure can have an average molecular weight in the range of from about 6 million Daltons to about 15 million Daltons. In one non-limiting embodiment of the present disclosure, the molecular weight of acrylamide polymer varies in the range of 8 million Daltons to 12 million Daltons.

The acrylamide polymers useful for the purpose of the present disclosure can be prepared by conventional methods known in the related art. Alternatively, commercially available polymers can also be procured. Suitable examples of such commercially available polymers can include, but are not limited to, FLOPAM® such as FA 920 VHM, FA 920 VHR, FA 920 SH, FA 920 SHR, FA 920 SD, FA 920 SHD, FA 920, FA 920 HD, AN 905 SH, AN 905 SHU, AN 910 SH, AN 910 SHU, AN 913 SH, AN 913 SHU, AN 923 SH, AN 923 SHU, AN 926 SH, and the like (available from SNF); and PRAESTOL such as 2500/2500TR, 2510, 2515/2515TR, 2520, 2525, 2530/2530TR, 2540/2540TR, 2640, 644BC, 650BC, and the like (available from Solenis).

The cellulose ether used in the rheology modifier composition of the present disclosure can be hydroxyalkyl cellulose ethers. Further, the cellulose ethers useful for the purpose of the present disclosure can be a glyoxal-treated cellulose ether or a non-glyoxal treated cellulose ether. Suitable examples of such cellulose ethers can include, but are not limited to, hydroxyethyl cellulose (HEC), hydroxypropyl cellulose (HPC), ethyl hydroxyethyl cellulose (EHEC), carboxymethyl cellulose (CMC), carboxymethyl hydroxyethyl cellulose (CMHEC), hydroxypropyl hydroxyethyl cellulose (HPHEC), methyl cellulose (MC), methyl hydroxypropyl cellulose (MHPC), methyl hydroxyethyl cellulose (MHEC), carboxymethyl methylcellulose (CMMC), hydrophobically modified carboxymethyl cellulose (HMCMC), hydrophobically modified hydroxyethyl cellulose (HMHEC), hydrophobically modified hydroxypropyl cellulose (HMHPC), hydrophobically modified ethyl hydroxyethyl cellulose (HMEHEC), hydrophobically modified carboxymethyl hydroxyethyl cellulose (HMCMHEC), hydrophobically modified hydroxypropyl hydroxyethyl cellulose (HMHPHEC), hydrophobically modified methyl cellulose (HM MC), hydrophobically modified methyl hydroxypropyl cellulose (HMMHPC), hydrophobically modified methyl hydroxyethyl cellulose (HMMHEC), hydrophobically modified carboxymethyl methylcellulose (HMCMMC), cationic hydroxyethyl cellulose (cationic HEC), cationic hydrophobically modified hydroxyethyl cellulose (cationic HMHEC), and any combinations thereof. In one non-limiting embodiment of the present disclosure, the cellulose ether can be a glyoxal-treated hydroxyethyl cellulose. In another non-limiting embodiment of the present disclosure, the cellulose ether can be non-glyoxal treated hydroxyethyl cellulose. In another non-limiting embodiment of the present disclosure, the cellulose ether can be hydroxyethyl cellulose or carboxymethyl cellulose either alone or in combination thereof.

Further, the cellulose ethers useful for the purpose of the present disclosure can be prepared by methods known in the art or any commercially available products can also be used such as NATROSOL 250 HHBR, NATROSOL 250 H4BR, NATROSOL 250 MHBR (available from Ashland LLC).

In one non-limiting embodiment of the present disclosure, the acrylamide polymer can be present in an amount ranging from about 0.05 wt. % to about 50.0 wt. %, or from about 0.05 wt. % to about 30.0 wt. %, of the total rheology modifier composition weight. In another non-limiting embodiment of the present disclosure, the acrylamide polymer is a cationic polymer and can be present in an amount of from about 0.05 wt. % to about 50.0 wt. %, or from about 0.05 wt. % to about 30.0 wt. % of the total rheology modifier composition weight. In one non-limiting embodiment of the present disclosure, the amount of cellulose ether can vary from about 50.0 wt. % to about 99.95 wt. %, or from about 70.0 wt. % to about 99.95 wt. %, of the total rheology modifier composition weight. In an embodiment of the present disclosure wherein the cellulose ether is a combination of hydroxyethyl cellulose and carboxymethyl cellulose, their total amount can vary in the range of from about 50.0 wt. % to about 99.95 wt. %, or from about 70.0 wt. % to about 99.95 wt. % of the total rheology modifier composition weight.

The rheology modifier composition of the present disclosure can further include at least one associative polymer selected from the group consisting of hydrophobically modified ethoxylated urethane polymer, hydrophobically modified polyacetal-polyether polymer, hydrophobically modified alkali swellable emulsions, hydrophobically modified aminoplasts, alkali swellable emulsions, and combinations thereof. In one non-limiting embodiment of the present disclosure, the associative polymer is hydrophobically modified polyacetal-polyether polymer.

The rheology modifier composition can further include at least one additive selected from the group consisting of surfactants; dispersants; thickeners; anticaking agents; antifoaming agents; preservatives; hydrophobic agents including waxes, silicones, and hydrocarbons; compatibilizers; adhesion promoters; stabilizers; crosslinkers; and any combinations thereof.

Suitable examples of dispersants can include, but are not limited to, polycarboxylic acids, carboxylated polyelectrolyte salts, tripolyphosphate salts and tetrapotassium pyrophosphate, ethoxylated fatty alcohols, amino alcohols, acrylic copolymers, naphthalene sulfonic acid-formaldehyde adducts, sulfonated fatty acids, soya lecithin, polyethylene glycol dioleate, soya lecithin, PEG dioleate, polyethylene glycol, polypropylene glycol, methoxy polyethylene glycol, polyethylene glycol monostearate, polyethylene glycol di-stearate, and combinations thereof.

The rheology modifier composition of the present disclosure is dry powder blend of the acrylamide polymer and the cellulose ether. The dry powder blend of the acrylamide polymer and the cellulose ether according to the present disclosure can be prepared by blending the acrylamide polymer and the cellulose ether. Another aspect of the present disclosure provides a method of preparing the rheology modifier composition of the present disclosure comprising blending (i) 0.05 wt. % to 70.0 wt. % of an acrylamide polymer having a weight average molecular weight greater than 6 million Daltons; and (ii) 30.0 wt. % to 99.95 wt. % of at least one cellulose ether. Any dry blending techniques or apparatus which are known in the related art for preparing the dry powder blends can suitably be used to blend the acrylamide polymer and the cellulose ether of the present disclosure. Suitable examples of such dry blending techniques or apparatus can include, but are not limited to, dry blending in mortar and pestle, ball mills, or attritor mills.

In another non-limiting embodiment of the present disclosure, the cellulose ether can be used in an amount of from about 50.0 wt. % to about 99.95 wt. %, or from about 70.0 wt. % to about 99.95 wt. %, based on the total weight of the rheology modifier composition. Similarly, the acrylamide polymer can be used in an amount of from about 0.05 wt. % to about 50.0 wt. % or from about 0.05 wt. % to about 30.0 wt. %, based on the total weight of the present rheology modifier composition.

Further, additional additives can also be added during the preparation of the present rheology modifier composition. Such additives can include at least one additive selected from the group consisting of surfactants; dispersants; thickeners; anticaking agents; antifoaming agents; preservatives; hydrophobic agents including waxes, silicones, and hydrocarbons; compatibilizers; adhesion promoters; crosslinkers; and any combinations thereof.

The rheology modifier composition of the present disclosure can be used in aqueous coating compositions. In particular, the rheology modifier composition of the present disclosure is useful in all kinds of coatings such as decorative and protective coatings and in paper coatings. The aqueous protective coating compositions are commonly known as latex paints or dispersion paints and have been known for a considerable number of years. The rheology modifiers used in the aqueous coating composition increase and maintain the viscosity at required level under specific processing conditions and end use situations. The aqueous protective coating composition need to provide good levelling and excellent sag resistance through the choice of rheology modifiers. Another aspect of the present disclosure provides a use of the rheology modifier composition of the present disclosure in aqueous based coatings, wherein the composition comprising a blend of (i) about 0.05 wt. % to about 70.0 wt. % of an acrylamide polymer; and (ii) about 30.0 wt. % to about 99.95 wt. % of at least one cellulose ether

Another aspect of the present disclosure provides an aqueous coating composition comprising the rheology modifier composition of the present disclosure as described hereinabove. The aqueous coating composition comprises or consists of or consists essentially of the rheology modifier composition comprising the acrylamide polymer having molecular weight greater than 6 million Daltons and at least one cellulose ether, at least one film forming polymer, and water.

The amount of the rheology modifier composition used in the aqueous coating composition of the present disclosure is the amount effective in providing the desired thickening and rheological properties to the aqueous coating composition and thus will depend upon both the rheological properties desired and the dispersion employed. Further, the rheology modifier composition can be added as a dry powder blend of the acrylamide polymer having molecular weight greater than 6 million Daltons and at least one cellulose ether in the aqueous coating composition of the present disclosure. Alternatively, the acrylamide polymer having a molecular weight greater than 6 million Daltons and at least one cellulose ether can be added individually in the aqueous coating composition of the present disclosure.

In an embodiment of the present disclosure wherein the rheology modifier composition can be added as a dry powder blend in the aqueous coating composition, the amount of rheology modifier composition can vary in the range of from about 0.01 wt. % to about 10.0 wt. %, based on the total weight of the aqueous coating composition. In another non-limiting embodiment of the present disclosure, the amount can vary in the range of from about 0.05 wt. % to about 5.0 wt. %, of the total weight of the aqueous coating composition.

In an embodiment of the present disclosure wherein the acrylamide polymer and the cellulose ether are added individually, their respective amount typically varies in the range of from about 0.01 wt. % to about 10.0 wt. % of the total aqueous coating composition weight. The acrylamide polymer and the cellulose ether, when added individually in the aqueous coating composition, are present as a synergistic dry blend thereof. In this case, their combined weight proportion can vary in the range of from about 0.01 wt. % to about 10.0 wt. %, or from about 0.05 wt. % to about 5.0 wt. % of the total aqueous coating composition weight.

The aqueous coating composition of the present disclosure is an aqueous polymer dispersion comprising at least one film forming polymer. The film forming polymer used in the aqueous coating composition of the present disclosure can be selected from a wide variety of polymers known in the related art. For instance, these film forming polymers can be derived from various ethylenically unsaturated monomers such as ethylene, vinyl and acrylic monomers. Examples of such monomers can include, but are not limited to, acrylic acid, methacrylic acid, methacrylic acid esters, styrene, α-methyl styrene, vinyl chloride, acrylonitrile, methacrylonitrile, ureido methacrylate, vinyl acetate, vinyl esters of branched tertiary monocarboxylic acids, itaconic acid, crotonic acid, maleic acid, fumaric acid, and ethylene. It is also possible to include C₄-C₈ conjugated dienes such as 1,3-butadiene, isoprene and chloroprene. The film forming polymers can also be copolymerized products of more than one monomer to achieve several desired properties, particularly for applications in latex paints with very little or no volatile organic compounds (VOCs). Examples of suitable film forming polymers can include, but are not limited to, homo- or co-polymers of vinyl acetate, methacrylic acid, methylacrylate, methylmethacrylate, ethylacrylate, butyl acrylate, styrene, ethylene, vinyl chloride, vinyl ester of versatic acid (VeoVa), vinyl propionate, butadiene, acrylonitrile, maleates, and fumarates. In one non-limiting embodiment of the present disclosure, the film forming polymer is selected from the group consisting of acrylics, vinyl-acrylics and styrene-acrylics, styrene-butadiene copolymers, vinyl acetate ethylenes, butadiene-acrylonitrile copolymers, epoxides, urethanes, polyamides, vinyl esters of versatic acid (VeoVa), and polyesters.

Examples of other suitable film forming polymers can include, but are not limited to, alkyds, cellulosics (cellulose nitrate and cellulose esters), coumarone-indenes, epoxies, esters, hydrocarbons, melamines, natural resins, oleo resins, phenolics, polyamides, polyesters, rosins, silicones, terpenes, urea, urethanes, and vinyls.

The amount of film forming polymer in the aqueous coating composition of the present disclosure can vary in the range of from about 5.0 wt. % to about 85.0 wt. %, based on the total aqueous coating composition weight. In one non-limiting embodiment of the present disclosure, the amount of film forming polymer can vary from about 40.0 wt. % to about 70.0 wt. %, or from about 50.0 wt. % to about 70.0 wt. %, based on the total aqueous coating composition weight.

The aqueous coating composition of the present disclosure can further include at least one pigment. The pigment can be selected from the group consisting of phthalocyanines, iron oxides, titanium dioxides, zinc oxide, indigo, hydrated aluminum oxide, barium sulfate, calcium silicate, clay, silica, talc, calcium carbonate, and mixtures thereof. Oftentimes, titanium dioxide grades used in the aqueous coating composition are surface modified with various inorganic oxides, such as silicates, aluminates, and zirconates. Aluminum silicate, nepheline syenite, mica, calcium carbonate, and/or diatomaceous earth can also be employed.

The type and amount of pigments present in the aqueous coating composition of the present disclosure dictate the performance properties, such as gloss, permeability, scrub resistance, tensile strength, and the like of the dried film. Hence, coatings are characterized by their pigment volume concentration (PVC). The PVC is a percentage and represents a volume ratio of pigment to total solids present in the dried film. PVC is defined as:

PVC %=Pigment Volume/(Pigment Volume+Latex Volume)×100

The point at which all voids between pigment particles are just filled with the film forming polymer is called the critical pigment-volume concentration (CPVC).

The aqueous coating composition of the present disclosure has a PVC upper limit of about 85% by weight. In one non-limiting embodiment of the present disclosure, the aqueous coating composition has a PVC upper limit of about 75% by weight. In another non-limiting embodiment of the present disclosure, the aqueous protective coating has a PVC upper limit of about 65% by weight. Similarly, the aqueous coating composition of the present disclosure has a PVC lower limit of about 10% by weight. In another non-limiting embodiment of the present disclosure, the aqueous coating composition has a PVC lower limit of about 20% by weight. More particularly, when the latex paint is a high gloss paint, the PVC is from about 15% to about 30% by weight; when the paint is a semi-gloss paint, the PVC is from about 20% to about 35% by weight; and when it is a flat paint, the PVC is from about 40% to about 85% by weight. The pigment can be added to the aqueous coating composition in dry powder form or in slurry form.

The balance of the aqueous coating composition is water. The water can be present in the film forming polymer dispersion and in other components of the aqueous coating composition. Alternatively, water can also be added separately to the aqueous coating composition.

The aqueous coating composition of the present disclosure can further comprise at least one additive. Examples of such additives can include, but are not limited to, surfactants; dispersants such as polyphosphates, amino alcohols, and acrylic copolymers; thickeners; anticaking agents; antifoaming agents such as nonsilicone and silicone types; plasticizers; extenders; preservatives; hydrophobic agents including waxes, silicones, and hydrocarbons; compatibilizers; adhesion promoters; crosslinkers; biocides; mildewcides; defoamers such as nonsilicone and silicone types; co-solvents; coalescents such as glycol ethers/esters; and any combinations thereof. These additives may be used in a manner and amount as known in the art of conventional aqueous coating compositions.

The aqueous coating composition described herein may be used in a variety of applications. In particular, the rheology modifier composition of the present disclosure is useful in all kinds of coatings such as decorative and protective coatings for architectural surfaces, for examples, walls, ceilings, doors, trim and the like; paper coatings; coatings for drywall, masonry, wood, metal, plastics, and primed surfaces and the like. In one non-limiting embodiment of the present disclosure, the coating composition is an architectural coating composition for interior and/or exterior architectural surfaces.

Another aspect of the present disclosure further provides a method of preparing the aqueous coating composition of the present disclosure wherein the method comprises mixing or blending of at least one film forming polymer, the rheology modifier composition of the present disclosure, and water under agitation. The pigments may advantageously be added to provide aqueous architectural coatings. The additives described hereinabove can also be added in any suitable order to the film forming, the rheology modifier, pigment, or combinations thereof.

The aqueous coating composition is a stable fluid that can be applied to a wide variety of surfaces materials as a protective coating. Examples of such materials can include, but are not limited to, paper, wood, concrete, metal, glass, ceramics, plastics, plaster, and roofing substrates such as asphaltic coatings, roofing felts, foamed polyurethane insulation; or to previously painted, primed, undercoated, worn, or weathered substrates.

Still another aspect of the present disclosure provides a method of applying the aqueous coating composition of the present disclosure to a variety of surfaces. The aqueous coating composition can be applied to one or more surfaces by a variety of conventional methods known to those of skill in the art. Examples of such method of applications can include, but are not limited to, application by aerosol spray, brush, roller, airless spray, air-assisted spray, electrostatic spray, high volume low pressure (HVLP) spray, and the like.

The rheology modifier composition of the present disclosure beneficially impacts certain rheological characteristics of paint formulations such as thickening efficiency, sag resistance, and the like. The present inventors have surprisingly found out that these compositions comprising the blend of acrylamide polymer and cellulose ether demonstrate some unique and unanticipated attributes such as improved efficiency (cost in use) and thickening efficiency with similar or improved application performance such as better dilution tolerance and improved hiding compared to pure acrylamide polymers or traditional non-associative thickeners such as cellulosic. These rheology modifier compositions enhance or improve overall thickening efficiency (Stormer viscosity, Brookfield viscosity and ICI viscosity) of a paint formulation and are also particularly suitable for difficult to thicken paint formulations such as vinyl acetate ethylene (VAE) latex paint. Additionally, the present rheology modifier compositions also provide a great deal of structure in architectural paints such as improved sag resistance and the like.

The following examples illustrate the presently disclosed and/or claimed inventive concept(s), parts and percentages being by weight, unless otherwise indicated. Each example is provided by way of explanation of the presently disclosed and/or claimed inventive concept(s), not limitation of the presently disclosed and/or claimed inventive concept(s). In fact, it will be apparent to those skilled in the art that various modifications and variations can be made in the presently disclosed and/or claimed inventive concept(s) without departing from the scope or spirit of the invention. For instance, features illustrated or described as part of one embodiment, can be used on another embodiment to yield a still further embodiment. Thus, it is intended that the presently disclosed and/or claimed inventive concept(s) covers such modifications and variations as come within the scope of the appended claims and their equivalents.

### EXAMPLES

### Test Methods

Unless indicated otherwise, the following test methods were utilized in the Examples that

### Thickening Efficiency Measurement

Thickening efficiency was measured by adding 0.15 wt. % based on actives of polymer samples obtained from examples into architectural coating formulation listed in Table 2. The thickening efficiency was measured by Stormer viscosity (KU), Brookfield viscosity and ICI viscosity of thickened architectural coating composition.

Brookfield viscosity was measured using a Brookfield viscometer with spindle #5 at 30 RPM and 25° C. It is expressed in mPa·s.

Stormer viscosity was measured using a Stormer viscometer as per the standard test method ASTM D562. It is expressed in Kreb Units (KU).

ICI viscosity was measured using an ICI cone and plate viscometer as per the standard test method ASTMD4287. It is expressed in mPa·s.

Sag resistance was measured by drawing down paint using a multi-notch drawdown applicator (anti-sag meter from Leneta Company) of varying clearances according to ASTM D4400. The sag resistance is reported as sag index number in mils.

### Example 1: Blend of HEC and Acrylamide Polymer (FLOPAM AN 923 SH)

All the samples of rheology modifier compositions of Example 1 were prepared by blending dry granular forms of hydroxyethyl cellulose (HEC HBR 250PA, available from Ashland LLC) and acrylamide polymers (FLOPAM AN 923 SH, available from SNF), a type of anionic acrylamide polymer of medium anionicity and 12-14 million Daltons Mw, in weight proportions as shown in Table 1. In a typical experiment, the hydroxyethyl cellulose (HEC HBR 250PA) was mixed with the acrylamide polymer (AN 923SH) in an 8 oz glass jar and blended using a Harbil mixture until a homogeneous mixture thereof was obtained.

### Control Example: Control Rheology Modifier Compositions (CE.1A and CE.1B)

Two different control rheology modifier compositions (CE.1A and CE.1B) were also prepared in the same manner as describe in Example 1, using either 100 wt. % of acrylamide polymer (FLOPAM AN 923SH) or 100 wt. % of HEC HBR 250PA, and compared with the rheology modifier compositions of Example 1.

TABLE 1
FLOPAM AN 923SH and HEC HBR 250 PA added to paint at 0.15 wt. %

| | Blend ratio (by wt. %) | Stormer | Brookfield | | Sag index |
|---|---|---|---|---|---|
| | HEC HBR250PA:FLOPAM | Viscosity | Viscosity | ICI | number |
| Examples | AN923SH | (KU) | (mPa · s) | (mPa · s) | (mils) |
| Ex. 1A | 85:15 | 64 | 1,213 | 0.473 | 10 |
| Ex. 1B | 70:30 | 65 | 1,147 | 0.529 | 14 |
| Ex. 1C | 50:50 | 63 | 986 | 0.560 | 12 |
| CE. 1A | 100:0 | 66 | 1,253 | 0.352 | 8 |
| CE. 1B | 0:100 | 63 | 1,040 | 0.644 | 14 |

The rheology modifier compositions of Example 1 were added to the paint formulation (shown in Table 2A and Table 2B) in 0.15 wt. %. The formulated aqueous paint compositions were equilibrated overnight before measuring Brookfield viscosity, Stormer viscosity and ICI viscosity responses. Sag resistance which is the ability of the architectural coating composition to resist sagging and dripping of wet coating was also measured. Higher the sag index number, greater the ability of the coating composition to prevent dripping of a freshly applied wet coatings.

TABLE 2A
47 PVC Styrene Butyl Acrylate Base Paint (Grind Formulation)

Amounts

| Ingredients | Lbs | Gal |
|---|---|---|
| Water | 294.00 | 35.30 |
| Proxel GXL | 2.00 | 0.21 |
| Tamol 731A | 12.00 | 1.30 |
| Strodex TH-4427 | 2.00 | 0.24 |
| Drewplus L-475 | 2.00 | 0.26 |
| AMP-95 | 1.00 | 0.13 |
| Strodex PK-90 | 1.00 | 0.08 |
| Optiwhite MX | 200.00 | 10.89 |
| Tronox CR-828 | 160.00 | 4.70 |

Proxel GXL, A biocide commercially available from Lonza Company.
Drewplus ™ L-475: A defoamer, commercially available from Ashland LLC.
Tamol ™ 731A: A dispersant, commercially available from The Dow Chemical Company.
Strodex ™ PK-90: A surfactant, commercially available from Ashland LLC.
Strodex ™ TH-4427: A surfactant, commercially available from Ashland LLC.
Tronox ® CR-828: Rutile titanium dioxide pigment, commercially available from Tronox Limited.
Optiwhite MX: Calcined aluminum silicate pigment, commercially available from Burgess pigment company.
AMP-95: Neutralizer, commercially available from Angus Chemical company.

TABLE 2B
47 PVC Styrene Butyl Acrylate Base
Paint (Let Down Formulation)

Amount

| Ingredients | Lbs | gal |
|---|---|---|
| Acronal 296D* | 280.00 | 32.33 |
| Optifilm 400** | 8.40 | 0.97 |
| Drewplus L-475 | 2.00 | 0.26 |
| Water | 112 | 13.39 |

*Acronal 296D: Styrene butyl acrylate emulsion, commercially available from Dow Chemicals
** Optifilm ™ Enhancer 400: a coalescent, commercially available from Eastman Chemical Company.

### Example 2: Blend of HEC and Acrylamide Polymer (PRAESTOL A 2530)

The rheology modifier compositions of this example were prepared in the same manner as described in Example 1, using acrylamide polymer (PRAESTOL A 2530 anionic polymer, available from Solenis) and hydroxyethyl cellulose (HEC HBR 250PA) powders in weight proportions as shown in Table 3.

These compositions were added in 0.15 wt. % to the paint formulation (shown in Table 2A and Table 2B). The viscosity data including Stormer viscosity, Brookfield viscosity and ICI viscosity; and sag index umber data of the paint formulation using these compositions is shown in Table 3.

TABLE 3
HEC HBR 250 PA and Anionic PRAESTOL A 2530 added to paint at 0.15 wt. %

| | Blend ratio (by wt. %) | Stormer | Brookfield | | Sag index |
|---|---|---|---|---|---|
| | HEC HBR 250 | Viscosity | Viscosity | ICI | number |
| Examples | PA:PRAESTOL A 2530 | (KU) | (mPa · s) | (mPa · s) | (mils) |
| Ex. 2A | 90:10 | 98 | 4,493 | 80.4 | 22 |
| Ex. 2B | 85:15 | 98 | 4,387 | 82.5 | 20 |
| Ex. 2C | 80:20 | 98 | 4,467 | 82.1 | 22 |
| Ex. 2D | 70:30 | 101 | 4,733 | 86.5 | 22 |
| Ex. 2E | 50:50 | 98 | 4,227 | 88.3 | 24 |
| Ex. 2F | 25:75 | 98 | 3,427 | 91.0 | 24 |
| CE. 2A | 100:0 | 93 | 4,240 | 68.1 | 22 |

### Example 3: Blend of HEC and Acrylamide Polymer (FLOPAM 920 VHM)

The rheology modifier compositions of this example were prepared in the same manner as described above in Example 2, except acrylamide polymer (FLOPAM 920 VHM, available from SNF) was used. The acrylamide polymer and the hydroxyethyl cellulose powders were dry blended in weight proportions as shown in Table 4. These rheology modifier compositions were added in 0.15 wt. % to the paint formulation (Table 2A and Table 2B). The Stormer viscosity (KU), Brookfield viscosity and ICI viscosity data including sag resistance index number is shown in Table 4.

TABLE 4
HEC HBR250 PA and FLOPAM 920VHM added to paint at 0.14 wt. %

| | Blend ratio | | | | |
|---|---|---|---|---|---|
| | HEC HBR250 | Stormer | Brookfield | | Sag index |
| | PA:Flopam | Viscosity | Viscosity | ICI | number |
| Examples | 920 VHM | (KU) | (mPa · s) | (mPa · s) | (mils) |
| Ex. 3A | 85:15 | 99 | 4,387 | 82.5 | 20 |
| Ex. 3B | 70:30 | 98 | 3,347 | 38.8 | 8 |
| Ex. 3C | 50:50 | 87 | 2,173 | 41.7 | 6 |
| CE. 3A | 100:0 | 66 | 1,253 | 35.2 | 8 |
| CE. 3B | 0:100 | 55 | 440 | 39.0 | 4 |

### Example 4: Impact of Acrylamide Polymer Mw on the Thickening Efficiency of a Paint

In this example, acrylamide polymers of different molecular weight (Mw) were used to evaluate the impact of acrylamide polymer Mw on the thickening efficiency of a paint formulation. Table 5 shows a list of acrylamide polymers including their molecular wt. (Mw) used (FLOPAM polymers available from SNF). These polymers were added at 0.34 wt. % (individual wt.) in a 47 PVC Styrene Butyl Acrylate Base paint formulation (Table 2A and Table 2B).

TABLE 5
acrylamide polymers added in 47 PVC Styrene Butyl
Acrylate Base Paint formulation (at 0.34 wt. %)

| | | PAM Mw. | PAM | Stormer | | Brookfield |
|---|---|---|---|---|---|---|
| | Acrylamide Polymer | (million | Charge | Viscosity | ICI | Viscosity |
| Examples | (PAM) | Daltons) | Density | (KU) | ((m · Pa · s) | (m · Pa · s) |
| Ex. 4A | Flopam FA 920VHM | 12-15 | Non-ionic | 149 | 68.1 | >10,000 |
| Ex. 4B | Flopam FA 920 SH | 7.1-8.5 | Non-ionic | 89 | 68.8 | 4,080 |
| Ex. 4C | Flopam FA 920 BPM | 4.0 | Non-ionic | 77 | 64.0 | 2,120 |
| Ex. 4D | Flopam AN 113 | ~6.9 | Anionic | 96 | 83.8 | 3,640 |
| Ex. 4E | Flopam AN 923 MPM | ~8 | Anionic | 92 | 88.5 | 3107 |
| Ex. 4H | Flopam AN 910 SH | 11-13 | Anionic | 121 | 85.2 | 7,147 |
| Ex. 4J | Flopam AN 923 VLM | ~3.5 | Anionic | 108 | 70.8 | 6,027 |

It is clear from the data in Table 5 that both the thickening efficiency (KU, Brookfield and ICI viscosities) of paint formulation decreases with decrease in acrylamide polymers Mw, particularly in non-ionic acrylamide polymers.

What is claimed is:

1. A rheology modifier composition comprising a blend of
(i) 0.05 wt. % to 70.0 wt. % of an acrylamide polymer having a weight average molecular weight of greater than 6 million Daltons; and
(ii) 30.0 wt. % to 99.95 wt. % of at least one cellulose ether.

2. The rheology modifier composition of claim 1, wherein the acrylamide polymer is a non-ionic homopolymer, an anionic copolymer or a cationic copolymer.

3. The rheology modifier composition of claim 1, wherein the acrylamide polymer is a cationic polymer.

4. The rheology modifier composition of claim 2, wherein the anionic copolymer comprises at least one monomer having one or more acid functional groups or anhydride functional group or combinations thereof, with one or more hetero atoms selected from the group consisting of S, N, O, and P.

5. The rheology modifier composition of claim 4, wherein the monomer is selected from the group consisting of acrylic acid, methacrylic acid, maleic acid or anhydride, itaconic acid or anhydride, crotonic acid, fumaric acid and citraconic acid.

6. The rheology modifier composition of claim 1, wherein the weight average molecular weight of the acrylamide polymer varies in the range of from about 6 million Daltons to about 15 million Daltons.

7. The rheology modifier composition of claim 1, wherein the weight average molecular weight of the acrylamide polymer varies in the range of from about 8 million Daltons to about 12 million Daltons.

8. The rheology modifier composition of claim 1, wherein the cellulose ether is a glyoxal or non-glyoxal treated cellulose ether selected from the group consisting of hydroxyethyl cellulose (HEC), hydroxypropyl cellulose (HPC), ethyl hydroxyethyl cellulose (EHEC), carboxymethyl cellulose (CMC), carboxymethyl hydroxyethyl cellulose (CMHEC), hydroxypropyl hydroxyethyl cellulose (HPHEC), methylcellulose (MC), methyl hydroxypropyl cellulose (MHPC), methyl hydroxyethyl cellulose (MHEC), carboxymethyl methyl cellulose (CMMC), hydrophobically modified carboxymethyl cellulose (HMCMC), hydrophobically modified hydroxyethyl cellulose (HMHEC), hydrophobically modified hydroxypropyl cellulose (HMHPC), hydrophobically modified ethyl hydroxyethyl cellulose (HMEHEC), hydrophobically modified carboxymethyl hydroxyethyl cellulose (HMCMHEC), hydrophobically modified hydroxypropyl hydroxyethyl cellulose (HMHPHEC), hydrophobically modified methyl cellulose (HMMC), hydrophobically modified methyl hydroxypropyl cellulose (HMMHPC), hydrophobically modified methyl hydroxyethyl cellulose (HMMHEC), hydrophobically modified carboxymethyl methyl cellulose (HMCMMC), cationic hydroxyethyl cellulose (cationic HEC), cationic hydrophobically modified hydroxyethyl cellulose (cationic HMHEC), and any combinations thereof.

9. The rheology modifier composition of claim 1, wherein the cellulose ether is hydroxyethyl cellulose (HEC) or carboxymethyl cellulose either alone or in combination thereof.

10. The rheology modifier composition of claim 1, wherein the cellulose ether is non-glyoxal treated hydroxyethyl cellulose ether.

11. The rheology modifier composition of claim 1, wherein the cellulose ether is glyoxal-treated hydroxyethyl cellulose ether.

12. The rheology modifier composition of claim 1, wherein the acrylamide polymer is present in an amount of from 0.05 wt. % to 50.0 wt. % or from 0.05 wt. % to 30.0 wt. %, and the cellulose ether is present in an amount of from 50.0 wt. % to 99.95 wt. % or from 70.0 wt. % to 99.95 wt. %.

13. The rheology modifier composition of claim 1, further comprising at least one associative polymer selected from the group consisting of hydrophobically modified ethoxylated urethane polymer, hydrophobically modified polyacetal-polyether polymer, hydrophobically modified alkali swellable emulsions, hydrophobically modified aminoplasts, alkali swellable emulsions and combinations thereof.

14. The rheology modifier composition of claim 13, wherein the associative polymer is hydrophobically modified polyacetal-polyether polymer.

15. The rheology modifier composition of claim 1, wherein the composition further comprises at least one additive selected from the group consisting of surfactants; dispersants; thickeners; anticaking agents; antifoaming agents; preservatives; hydrophobic agents including waxes, silicones, and hydrocarbons; compatibilizers; adhesion promoters; crosslinkers; and any combinations thereof.

16. The rheology modifier composition of claim 1, wherein the composition is a dry powder blend.

17. A method of preparing the composition of claim 1 comprising blending (i) 0.05 wt. % to 70.0 wt. % of an acrylamide polymer having a weight average molecular weight greater than 6 million Daltons; and (ii) 30.0 wt. % to 99.95 wt. % of at least one cellulose ether.

18. The method of claim 17, wherein the acrylamide polymer is present in an amount of from 0.05 wt. % to 50.0 wt. % or from 0.05 wt. % to 30.0 wt. %, and the cellulose ether is present in an amount of from 50.0 wt. % to 99.95 wt. % or from 70.0 wt. % to 99.95 wt. %.

19. The method of claim 17, further comprising the step of blending at least one additive selected from the group consisting of surfactants; dispersants; thickeners; anticaking agents; antifoaming agents; preservatives; hydrophobic agents including waxes, silicones, and hydrocarbons; compatibilizers; adhesion promoters; crosslinkers; and combinations thereof.

20. Use of a rheology modifier composition in aqueous-based coatings, wherein the composition comprises a blend of (i) 0.05 wt. % to 70.0 wt. % of an acrylamide polymer having a weight average molecular weight greater than 6 million Daltons; and (ii) 30.0 wt. % to 99.95 wt. % of at least one cellulose ether.

21. The use of the rheology modifier composition of claim 20, wherein the acrylamide polymer is present in an amount of from 0.05 wt. % to 50.0 wt. % or from 0.05 wt. % to 30.0 wt. %, and the cellulose ether is present in an amount of from 50.0 wt. % to 99.95 wt. % or from 70.0 wt. % to 99.95 wt. %.

22. An aqueous coating composition comprising:
(ia) 0.01 wt. % to 10.0 wt. % of the composition of claim 1 or (ib) 0.01 wt. % to 10.0 wt. % of an acrylamide polymer having a weight average molecular weight greater than 6 million Daltons; and 0.01 wt. % to 10.0 wt. % of at least one cellulose ether;
(ii) 5.0 wt. % to 85.0 wt. % of at least one film forming polymer; and
(iii) 5.0 wt. % to 15.0 wt. % of water, based on the total weight of the coating composition.

23. The aqueous coating composition of claim 22, wherein the acrylamide polymer and the cellulose ether are both present in the coating composition as a blend.

24. The aqueous coating composition of claim 22, wherein the film forming polymer is selected from the group consisting of acrylics, vinyl acrylics, and styrene-acrylics styrene-butadiene copolymers, vinyl acetate ethylenes, butadiene-acrylonitrile copolymers, epoxides, urethanes, polyamides, vinyl esters of versatic acid (VeoVa), and polyesters.

25. The aqueous coating composition of claim 22, wherein the coating composition further comprises at least one pigment selected from the group consisting of phthalocyanines, iron oxides, titanium dioxides, zinc oxide, indigo, hydrated aluminum oxide, barium sulfate, calcium silicate, clay, silica, talc, calcium carbonate, and mixtures thereof.

26. The aqueous coating composition of claim 25, wherein the coating composition has a pigment volume concentration (PVC) in the range of from 15% to 85%.

27. The aqueous coating composition of claim 22, wherein the coating composition further comprises at least one additive selected from the group consisting of surfactants; dispersants; thickeners; anticaking agents; antifoaming agents; plasticizers; extenders; preservatives; hydrophobic agents including waxes, silicones, and hydrocarbons; compatibilizers; adhesion promoters; crosslinkers; biocides; mildewcides; defoamers; co-solvents; coalescents; and any combinations thereof.

28. The aqueous coating composition of claim 22, wherein the aqueous coating composition is an architectural coating composition.
